(19) United States
(12) Patent Application Publication
(10) Pub. No.: US 2025/0301202 A1
(43) Pub. Date: Sep. 25, 2025

(54) IDENTIFYING SKIPPABLE SEGMENTS WITHIN VIDEOS

(71) Applicant: Google LLC, Mountain View, CA (US)

(72) Inventors: Tianchun Yang, Pacifica, CA (US); Nikhil Gopalam, San Francisco, CA (US); Yu Su, Foster City, CA (US); Albert Choi, San Mateo, CA (US); Ying Li, Sunnyvale, CA (US); Ricardo Escutia, Chicago, IL (US); Yaqing Liu, San Bruno, CA (US); Katherine Garvey Danser, San Francisco, CA (US); Catherine Cardinal, San Francisco, CA (US)

(21) Appl. No.: 19/084,601

(22) Filed: Mar. 19, 2025

Related U.S. Application Data
(60) Provisional application No. 63/567,388, filed on Mar. 19, 2024.

(51) Int. Cl. H04N 21/472; H04N 21/431; H04N 21/442; H04N 21/466; H04N 21/845

(52) U.S. Cl. CPC H04N 21/47217; H04N 21/4312; H04N 21/44204; H04N 21/4666; H04N 21/8456

(57) ABSTRACT

Methods, systems, and apparatus, including computer programs encoded on computer storage media, for identifying skippable segments within videos. One of the methods includes receiving, during playback of a video on a display of a device of a user, a user input at a first timestamp of the video; in response to receiving the user input at the first timestamp of the video, determining whether the first timestamp is associated with a skippable segment within the video; and in response to determining that the first timestamp is associated with a skippable segment within the video, identifying a second timestamp associated with the skippable segment of the video as a skip location.

### CROSS-REFERENCE TO RELATED APPLICATIONS

This application claims priority to U.S. Provisional Application No. 63/567,388, filed on Mar. 19, 2024. The disclosure of the prior application is considered part of and are incorporated by reference in the disclosure of this application.

### BACKGROUND

This specification relates to generating outputs conditioned on inputs using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of operations to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that determines, during playback of a video, whether a first timestamp is associated with a skippable segment within the video. If the system determines that the first timestamp is associated with a skippable segment, the system identifies a skip location. The system then skips playback of the video to the skip location.

In general, one innovative aspect of the subject matter described in this specification can be embodied in methods that include the actions of receiving, during playback of a video on a display of a device of a user, a user input at a first timestamp of the video; in response to receiving the user input at the first timestamp of the video, determining whether the first timestamp is associated with a skippable segment within the video; and in response to determining that the first timestamp is associated with a skippable segment within the video, identifying a second timestamp associated with the skippable segment of the video as a skip location.

In some implementations, the method further comprises providing, for presentation on the device, a user interface element controllable by the user to skip playback of the video to the skip location; and in response to receiving an input to the user interface element, skipping playback of the video to the skip location by causing the video to be played from the second timestamp.

In some implementations, the method further comprises skipping playback of the video to the skip location by causing the video to be played from the second timestamp.

In some implementations, the method further comprises providing, for presentation on the device, an indicator for the skip location.

In some implementations, the user input is a request to skip a portion of the video.

In some implementations, the method further comprises maintaining data identifying one or more skippable segments within the video, and wherein determining whether the first timestamp is associated with a skippable segment within the video comprises determining whether the first timestamp is part of one of the one or more skippable segments.

In some implementations, the data identifying one or more skippable segments within the video comprises, for each skippable segment, a respective start timestamp and a respective end timestamp, and wherein determining whether the first timestamp is part of one of the one or more skippable segments further comprises: for each of the one or more skippable segments, determining whether an amount of time between the first timestamp and the respective end timestamp for the skippable segment meets a threshold amount of time.

In some implementations, the skippable segment is defined by a start timestamp and an end timestamp, and wherein identifying a second timestamp associated with the skippable segment within the video as a skip location comprises identifying a timestamp that is a threshold amount of time before the end timestamp as the second timestamp.

In general, another innovative aspect of the subject matter described in this specification can be embodied in methods that include the actions of obtaining data identifying one or more segments within a video, wherein each of the one or more segments spans a corresponding segment time range within the video; obtaining one or more time ranges within the video, wherein each time range has been designated as a time range within the video that has been skipped by users; for each of the one or more segments: for each of the one or more time ranges: determining a respective overlap of the time range with the corresponding segment time range for the segment; determining whether the respective overlap meets a threshold overlap; and in response to determining that the respective overlap meets the threshold overlap, identifying the segment as a skippable segment within the video.

In some implementations, the method further comprises determining that the video has a threshold number of user interactions, comprising: obtaining a number of views for the video and a number of skips for the video; and determining that the number of views meets a threshold number of views and that the number of skips meets a threshold number of skips.

In some implementations, the method further comprises identifying the one or more segments within the video, comprising: processing a prompt comprising at least a text transcript for the video using a language model neural network to generate an output identifying one or more portions of text of the text transcript, each corresponding to a segment within the video; and identifying one or more segments within the video from the portions of text.

In some implementations, identifying the one or more segments within the video further comprises: obtaining a segment start timestamp and a segment end timestamp for each of the one or more segments within the video based on the portion of text corresponding to each segment.

In some implementations, each designated time range has been skipped in a threshold proportion of views of the video.

In some implementations, the method further comprises for each of the identified skippable segments within the video, identifying a respective second timestamp associated with the identified skippable segment as a respective skip location.

In some implementations, the method further comprises receiving, during playback of the video on a display of a device of a user, a user input at a first timestamp of the video; in response to receiving the user input at the first timestamp of the video, determining whether the first timestamp is associated with a skippable segment of the identified skippable segments within the video; and in response to determining that the first timestamp is associated with a skippable segment of the identified skippable segments within the video, identifying a second timestamp associated with the skippable segment within the video as a skip location.

In some implementations, the method further comprises providing, for presentation on the device, a user interface clement controllable by the user to skip playback of the video to the skip location; and in response to receiving an input to the user interface element, skipping playback of the video to the skip location by causing the video to be played from the second timestamp.

In some implementations, the method further comprises skipping playback of the video to the skip location by causing the video to be played from the second timestamp.

In some implementations, the method further comprises providing, for presentation on the device, an indicator for the skip location.

Other embodiments of these aspects include corresponding computer systems, apparatus, and computer programs recorded on one or more computer storage devices, each configured to perform the actions of the methods.

Particular embodiments of the subject matter described in this specification can be implemented so as to realize one or more of the following advantages.

Conventional techniques for skipping playback of a video may require a user to manually seek through the video, for example by manually dragging a seek bar (also known as scrubber) or skipping a predetermined time interval. Manually seeking, for example with a seek bar, may also have limited accuracy, which may be further impacted by physical limitations or experience level of the user. For example, while it may be possible for a user to make relatively coarse adjustments using the seek bar, users may struggle to make fine adjustments needed to navigate to a particular section of the video. Manually seeking through the video to get to a desired section of the video may therefore require multiple forward seeks and backward seeks.

The system described in this specification assists a user to skip sections of a video during playback of the video without requiring the user to manually seek through the video. In this way, the task of seeking, or navigating, within a video is improved by reducing the number of manual and unassisted seeking operations that the user must otherwise perform. For example, the system receives a user input at a first timestamp during playback of a video, and determines whether the first timestamp is associated with a skippable segment within the video. The system can identify a skip location within the skippable segment, and skip playback of the video to the skip location. The system can thus determine which section of the video is to be skipped, and assist the user to skip over that section.

In addition, multiple forward seeks and backward seeks may require large amounts of network bandwidth for serving different sections of the video for each seek for playback to the user. The system described in this specification can reduce the amount of network bandwidth used by not needing different sections of the video for multiple seeks to be served.

Video playback is also computationally expensive. Inaccurate and prolonged seeking operations increase computational resource use in addition to increasing the time needed by the user and potentially increasing user frustration.

Some conventional techniques may only provide a user the option to skip a section of the video at predetermined points in the video, such as near the beginning of the video or near the end of the video.

The system described in this specification provides the user the ability to skip sections of the video at a variety of points in the video. In some examples, the system can provide the user the ability to skip sections of the video based on user input. For example, the system can provide the user the ability to skip sections of the video in response to receiving a user input at a first timestamp of the video, and determining that the first timestamp is associated with a skippable segment within the video. The user may provide the user input at any particular timestamp within the video. The system can thus determine if the particular timestamp is associated with a skippable segment and, if so, provide the user the ability to skip the skippable segment.

In some examples, the system can provide the user the ability to skip sections of the video in response to determining that the current timestamp of playback of the video is associated with a skippable segment within the video. The system can thus determine if the current timestamp is associated with a skippable segment and, if so, provide the user the ability to skip the skippable segment.

In some implementations, the system described in this specification identifies skippable segments with more fidelity than segments identified only based on content. For example, the system identifies skippable segments using a combination of information about content of the video and data about the interactions of users with the video. The system can identify segments within a video that are divided based on content. The system can also obtain time ranges within a video that have been designated as being skipped by users. The system can determine if the overlap of the time ranges that have been designated as being skipped with the time ranges for the segments that are divided based on content meets a threshold overlap. If the overlap meets the threshold overlap, the system can identify the segment as a skippable segment. By combining information about content of the video and data about the interactions of users with the video, the system can identify skippable segments that include skippable content and have been skipped at a high rate by users.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1C show an example presentation of a video for playback on a user device.

FIG. 2 is a diagram of an example system for identifying a skip location.

FIG. 3 is a flow diagram of an example process for identifying a skip location.

FIG. 4 is a diagram of an example system for identifying skippable segments within a video.

FIG. 5 is a flow diagram of an example process for identifying skippable segments within a video.

Like reference numbers and designations in the various drawings indicate like elements.

### DETAILED DESCRIPTION

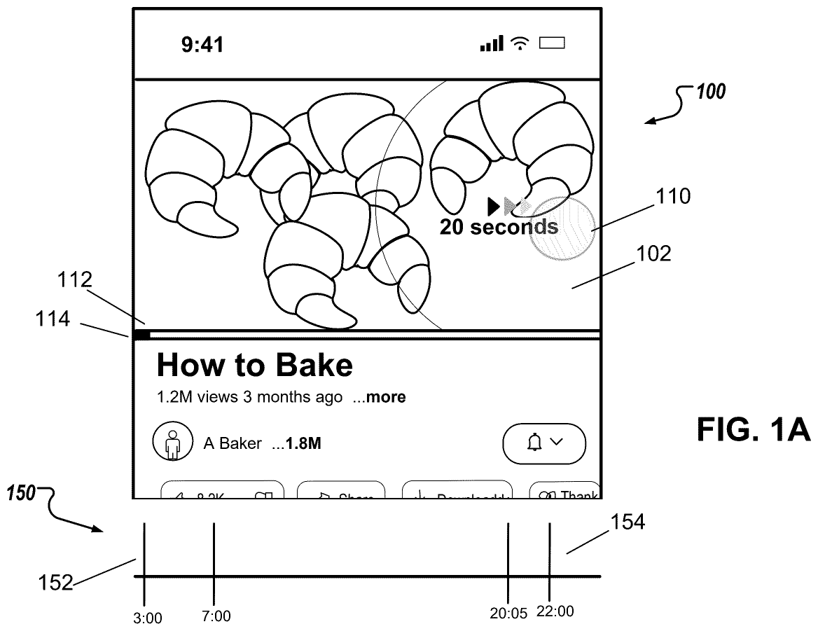

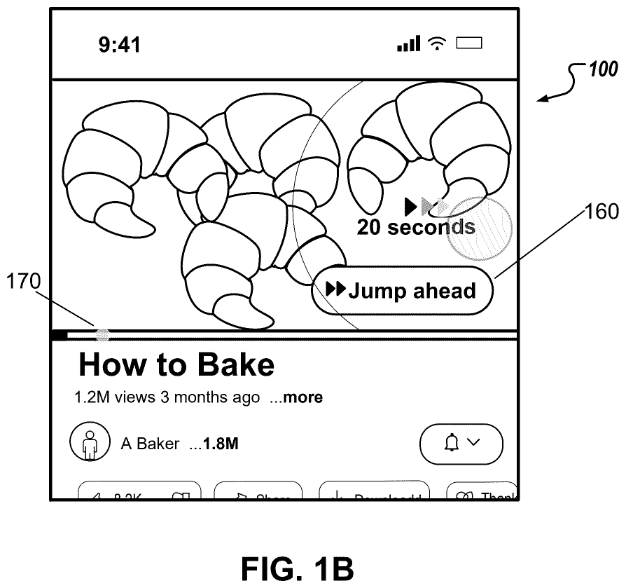

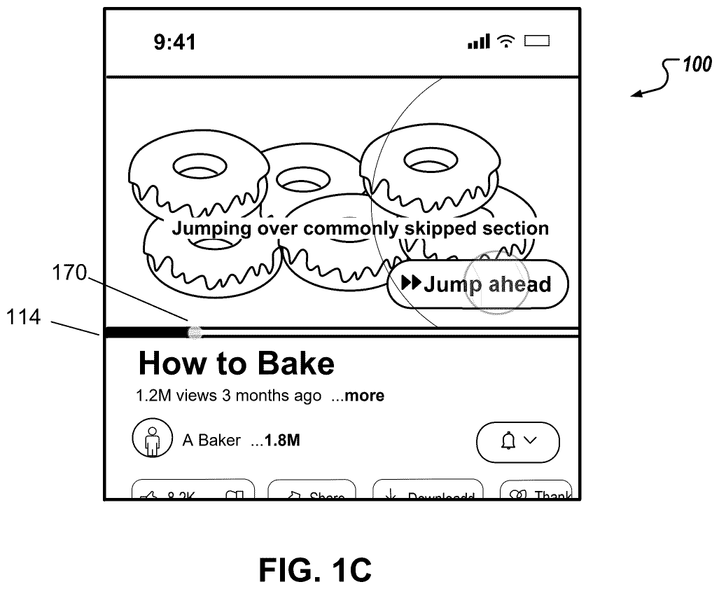

FIGS. 1A-1C show an example presentation 100 of a video 102 for playback on a user device.

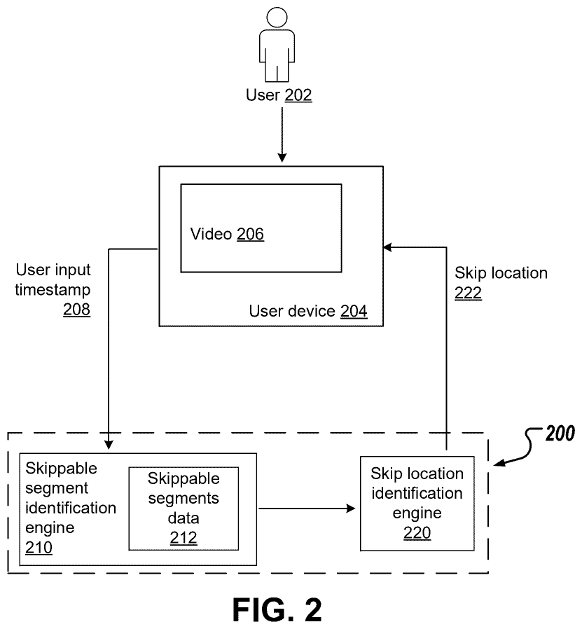

During playback of the video, a system such as the system 200 described with reference to FIG. 2 can determine a skip location 130 within the video 102 and skip playback of the video 102 to the skip location 130.

As shown in FIG. 1A, the system can receive a user input 110 during playback of the video 102 to a user of the user device. The video 102 can be presented in a user interface of a user device, for example. In the example of FIGS. 1A-1C, the video 102 is an instructional video about baking.

The system can receive the user input 110 through the user interface at a particular timestamp 112 of the video 102. The bar 114 represents the elapsed progress of playback of the video from the beginning of the video. In the example of FIG. 1A, the user has provided a user input 110 at 3 minutes and 30 seconds elapsed from the beginning of the video. The system thus receives the user input at the timestamp 112 of 3:30 minutes.

The user input 110 can be a request to skip a portion of the video. For example, the user input 110 can be a gesture or type of interaction with the user interface that indicates the user wants to skip a portion of the video. As an example, if the video 102 is played on a device with a touchscreen, the user input 110 can be a double tap on the portion of the user interface that displays the video 102.

The system can determine whether the timestamp 112 is associated with a skippable segment within the video 102. For example, the system can maintain data identifying one or more skippable segments within the video 102. FIG. 1A shows an example visualization 150 of the data identifying the skippable segment 152 and the skippable segment 154. The data identifying the skippable segments 152 and 154 can include a range of time that each skippable segment spans within the video, i.e., a start timestamp and an end timestamp, for each skippable segment. For example, the data identifying the skippable segment 152 can include the start timestamp 3:00 and the end timestamp 7:00 minutes. The data identifying the skippable segment 154 can include the start timestamp 20:05 and the end timestamp 22:00 minutes.

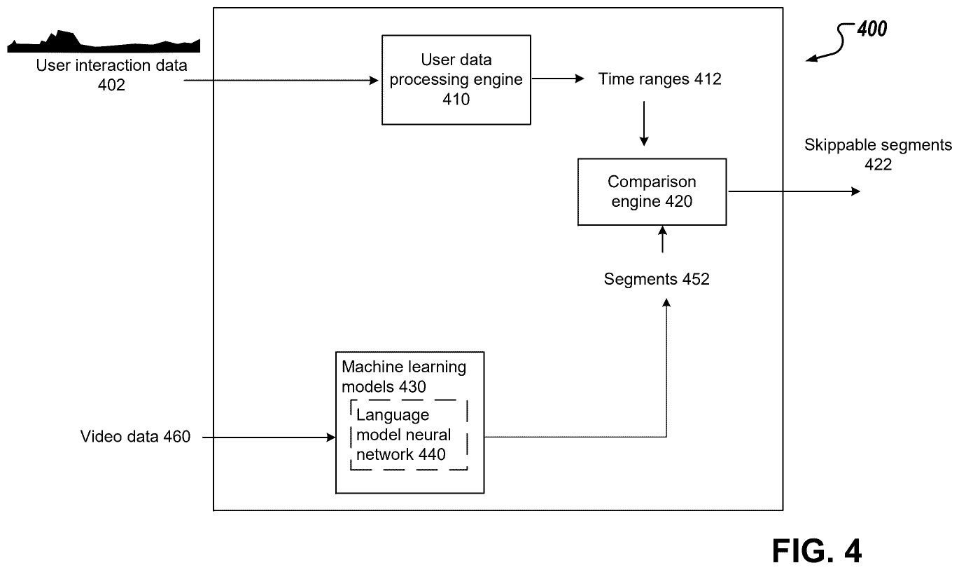

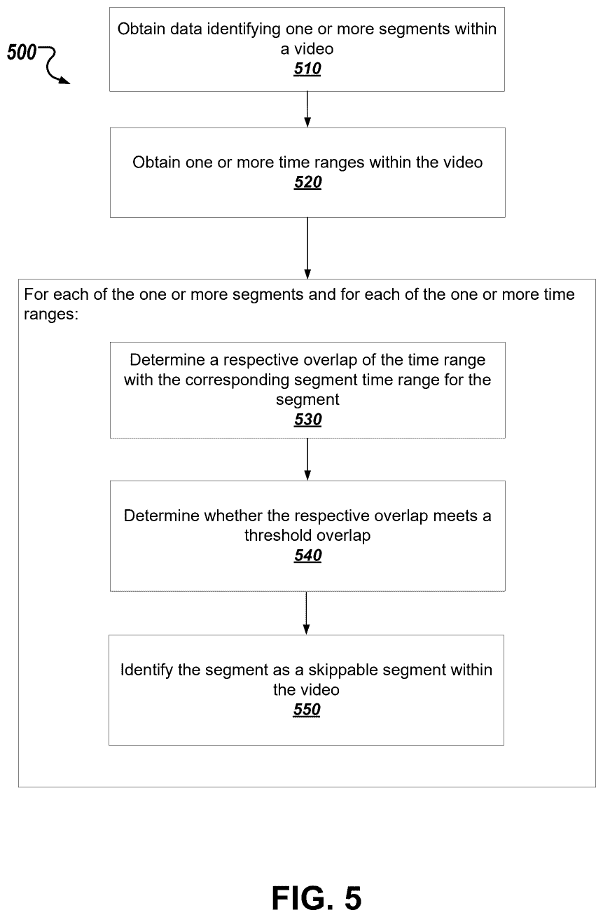

In some implementations, the system can generate the data identifying one or more skippable segments as described with reference to FIGS. 4-5.

The system can determine that the timestamp 112 is associated with a skippable segment if the first timestamp is part of the skippable segment. For example, the system can determine that the timestamp 112 is associated with the skippable segment 152 because 3:30 minutes is between the start timestamp 3:00 and the end timestamp 7:00 minutes.

In some examples, the system can determine that the timestamp 112 is associated with a skippable segment if the first timestamp is part of the skippable segment, and if the first timestamp is at least a threshold amount of time away from the end timestamp of the skippable segment. The threshold amount of time can be a default or predetermined amount of time. For example, the threshold amount of time can be 10 seconds. The system can determine that the timestamp 112 is associated with the skippable segment 152 because 3:30 minutes is between the start timestamp 3:00 and the end timestamp 7:00 minutes, and because 3:30 minutes is more than 10 seconds away from the end timestamp 7:00 minutes.

In response to determining that the first timestamp 112 is associated with the skippable segment 152, the system identifies a timestamp associated with the skippable segment 152 as a skip location. For example, the timestamp can be a threshold amount of time before the end timestamp. As an example, the threshold amount of time can be two seconds. In the example of FIGS. 1A-1C, the system can identify the skip location as 6:58 minutes, or two seconds before the end timestamp 7:00.

As shown in FIG. 1B, the system can provide a user interface element 160 that allows the user to skip playback of the video 102 for presentation on the device. For example, the user interface element 160 can be a button. In the example of FIG. 1B, the button is labeled “Jump ahead.”

In some implementations, the system can also provide an indicator 170 for the skip location for presentation on the device. For example, referring to FIG. 1B, the system can provide the indicator 170 for display at 6:58 minutes on the portion of the user interface that displays the video 102.

FIG. 1C shows that the user has selected the “Jump ahead” button. In response to receiving the input from the user, the system can skip playback of the video 102 to the skip location by causing the video 102 to be played from the timestamp 6:58 minutes. For example, FIG. 1C shows that the bar 114 has extended from 3:00 in FIGS. 1A and 1B, to 6:58 in FIG. 1C, to reflect the forward progress of playback of the video 102.

In some implementations, the system can provide an indicator that the playback of the video 102 has been skipped. For example, FIG. 1C also shows an indicator, “Jumping over commonly skipped section,” that provides context for the transition between the presentation of FIG. 1A and the presentation of FIG. 1C.

FIG. 2 is a diagram of an example system 200 for identifying a skip location 222. The system 200 is an example of a system implemented as computer programs on one or more computers in one or more locations in which the systems, components, and techniques described in this specification are implemented.

To identify the skip location 222, the system 200 receives a user input during playback of a video 206 on a user device 204. The system 200 receives the user input from a user 202 of the user device 204 at a timestamp 208. For example, the timestamp 208 can refer to the number of hours, minutes, and/or seconds of elapsed progress of the video 206 when the user 202 provided the user input to the user device 204.

In some implementations, the components of the system 200 can run on the user device 204. The user device 204 can be any type of computer or computing device that has a display and is configured to receive an input from the user 202. For example, the user device 204 can be a computer, laptop, tablet, or mobile phone that has a display and can receive user inputs through interfaces such as a keyboard, mouse, touchpad, or touchscreen. The user device 204 is configured to receive inputs such as text, visual data, and/or audio data.

In some implementations, the components of the system 200 can run on one or more computers remote from the user device 204. The components of the system 200 can communicate with the user device 204 over a data communication network, e.g., the Internet.

The user device 204 can be configured to display videos on a display of the user device 204, for example, in a user interface. Example presentations that can be displayed on the user device 204 are shown above in FIGS. 1A-1C.

The user interface can include user interface elements such as buttons that allow the user 202 to interact with the content displayed in the user interface. For example, the user interface elements can allow the user to request to skip a portion of the video. The system 200 can process the user inputs from the user 202 to update the content displayed in the user interface.

The system 200 can use a skippable segment identification engine 210 and a skip location identification engine 220 to identify the skip location 222, as described below.

The skippable segment identification engine 210 determines whether the user input timestamp 208 is associated with a skippable segment of the video 206. For example, the skippable segment identification engine 210 can maintain skippable segments data 212 that identifies one or more skippable segments within the video 206. The skippable segment identification engine 210 can also maintain skippable segments data for other videos that also have skippable segments. The skippable segments data 212 can identify each skippable segment for the video 206 using a start timestamp and an end timestamp. In some implementations, the system 200 or another system can generate the skippable segments data 212. Generating the skippable segments data 212 is described in more detail below with reference to FIGS. 4-5.

In some implementations, the skippable segment identification engine 210 can maintain the skippable segments data 212 on one or more computers remote to the user device 204. In some examples, the skippable segment identification engine 210 can obtain skippable segments data 212 for the video 206 in response to determining that playback of the video 206 has begun. In some examples, in response to determining that playback of the video 206 has begun, the skippable segment identification engine 210 can obtain data representing user interactions, such as views and skips, over a certain period of time.

In some examples, in response to determining that the video 206 has a threshold number of user interactions, the skippable segment identification engine 210 can obtain skippable segments data 212 for the video 206. In some examples, in response to determining that the video 206 has a threshold age (e.g., the elapsed amount of time that the video has been available for viewing by users), the skippable segment identification engine 210 can obtain skippable segments data 212 for the video 206.

The skippable segment identification engine 210 is configured to determine whether the user input timestamp 208 is associated with a skippable segment of the video 206 by determining whether the user input timestamp 208 is in between a start timestamp and an end timestamp for any of the skippable segments for the video 206. In response to determining that the user input timestamp 208 is in between the start timestamp and the end timestamp for a skippable segment, the skippable segment identification engine 210 can determine that the user input timestamp 208 is associated with the skippable segment.

In some examples, the skippable segment identification engine 210 can also determine whether the user input timestamp 208 is more than a threshold amount of time prior to the end timestamp. In response to determining that the user input timestamp 208 is more than a threshold amount of time prior to the end timestamp, the skippable segment identification engine 210 can determine that the user input timestamp 208 is associated with the skippable segment.

If the skippable segment identification engine 210 determines that the user input timestamp 208 is associated with a skippable segment of the video 206, the system 200 can provide data identifying the skippable segment to the skip location identification engine 220.

The skip location identification engine 220 is configured to determine a timestamp associated with the skippable segment identified by the skippable segment identification engine 210. For example, the skip location identification engine 220 can determine a timestamp that is a threshold amount of time prior to the end timestamp.

The system 200 can identify the timestamp determined by the skip location identification engine 220 as the skip location 222.

In some examples, the system 200 can skip playback of the video to the skip location 222 by causing the video to be played from the timestamp identified by the skip location identification engine 220.

In some examples, as described above with reference to FIG. 1B, the system 200 can provide a user interface element controllable by the user 202 for presentation on the user device 204. In response to receiving an input to the user interface element, the system 200 can skip playback of the video to the skip location 222 by causing the video to be played from the timestamp identified by the skip location identification engine 220.

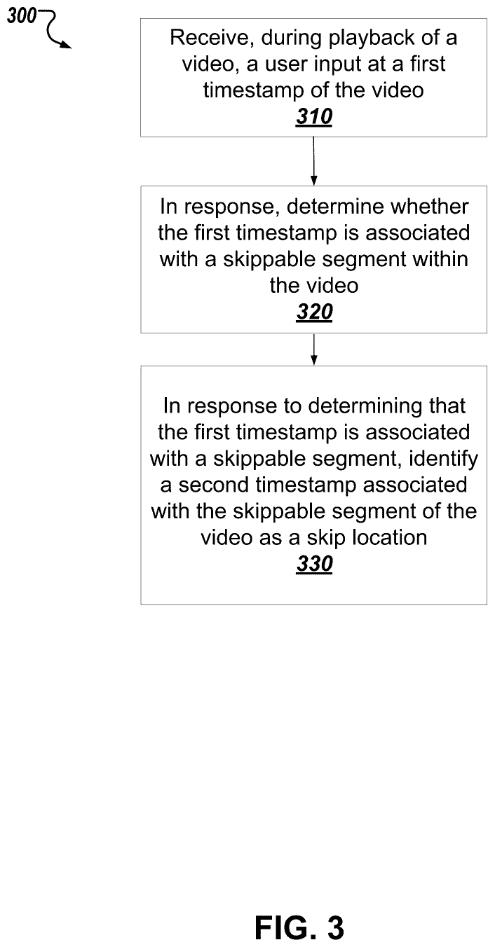

FIG. 3 is a flow diagram of an example process 300 for identifying a skip location. The process 300 can be performed by any appropriate system, e.g., the system 200 described above with reference to FIG. 2.

The system receives, during playback of a video on a display of a device of a user, a user input at a first timestamp of the video (step 310). In some examples, the user input is a request to skip a portion of the video.

In response to the user input at the first timestamp of the video, the system determines whether the first timestamp is associated with a skippable segment within the video (step 320). For example, the system can maintain data identifying one or more skippable segments within the video. The system can determine whether the first timestamp is part of one of the one or more skippable segments. For example, the system can determine whether the first timestamp is in between the start timestamp and end timestamp of one of the skippable segments. The system can determine that the first timestamp is associated with a skippable segment if the system determines that the first timestamp is in between the start timestamp and end timestamp of one of the skippable segments. In some examples, the one or more skippable segments are determined based on content and user interactions, as described below with reference to FIGS. 4-5.

In some implementations, to determine whether the first timestamp is part of a skippable segment, the system can also determine whether the amount of time between the first timestamp and the end timestamp for the skippable segment meets a threshold amount of time. That is, the system determines that the first timestamp is associated with a skippable segment if the first timestamp is in between the start timestamp and end timestamp, and the first timestamp is a threshold amount of time before the end timestamp.

In some implementations, determining whether the first timestamp is associated with a skippable segment also includes determining whether the video has a threshold number of user interactions, such as views and skips, over a certain period of time. In response to determining that the video has a threshold number of user interactions, the system can determine whether the first timestamp is associated with a skippable segment.

In some implementations, determining whether the first timestamp is associated with a skippable segment also includes determining whether the video has a threshold age. In response to determining that the video has a threshold age, the system can determine whether the first timestamp is associated with a skippable segment.

If the system determines that the first timestamp is not associated with a skippable segment within the video, the system does not perform step 330.

In response to determining that the first timestamp is associated with a skippable segment within the video, the system identifies a second timestamp associated with the skippable segment of the video as a skip location (step 330).

In some examples, the skip location is the end timestamp of the skippable segment.

In some examples, the skip location is a threshold amount of time before the end timestamp of the skippable segment. If playback is skipped to the skip location, the user is less likely to lose context during the transition from the content of the video at the first timestamp and the content of the video of the second timestamp. For example, the system can identify a timestamp that is a threshold amount of time before the end timestamp as the second timestamp.

In some implementations, the system skips playback of the video to the skip location directly. For example, the system causes the video to be played from the second timestamp.

In some implementations, the system provides a user interface element controllable by the user to skip playback of the video to the skip location for presentation on the device. In response to receiving an input to the user interface element, the system skips playback of the video to the skip location. For example, the system causes the video to be played from the second timestamp.

In some implementations, the system provides an indicator for the skip location for presentation on the device. The system can use the indicator to provide context for the user for the skip location.

In some implementations, to determine whether the first timestamp is associated with a skippable segment within the video, the system obtains one or more time ranges within the video that have been designated as skipped by users. For example, the system can obtain the one or more time ranges from user interaction data from a certain period of time as described with reference to step 520 of FIG. 5. The system can determine whether the first timestamp is within a particular time range of the time ranges. In response to determining that the first timestamp is within a particular time range, the system can obtain data identifying one or more segments. For example, the system can obtain data identifying one or more segments as described with reference to step 510 of FIG. 5. For each of the one or more segments, the system can determine whether the overlap of the particular time range with the corresponding segment time range for the segment meets a threshold overlap. Determining whether the overlap meets the threshold overlap is described in more detail below with reference to FIG. 5. In response to determining that the overlap of the particular time range with the corresponding segment time range for the segment meets a threshold overlap, the system can identify the segment as a skippable segment. The system can thus determine that the first timestamp is associated with a skippable segment.

In some implementations, the system can provide the user interface element controllable by the user to skip playback of the video to the skip location for presentation on the device in response to determining that the current timestamp of playback of the video is associated with a skippable segment. In some examples, during playback of the video, the system can obtain the current timestamp. In response to determining that the current timestamp is associated with a skippable segment, the system can provide the user interface element controllable by the user to skip playback of the video for presentation. In some examples, the system can obtain the current timestamp at a regular interval during playback of the video, e.g., every second, every two seconds, every five seconds, etc.

In some examples, the system can obtain a measure of confidence for each skippable segment within the video. For skippable segments that have a measure of confidence that is over a threshold confidence, the system can determine a skip location and provide the user interface element for presentation without receiving a user input that is a request to skip playback.

FIG. 4 is a diagram of an example system 400 for identifying skippable segments within a video. The system 400 is an example of a system implemented as computer programs on one or more computers in one or more locations in which the systems, components, and techniques described in this specification are implemented.

In some examples, the system 200 described with reference to FIG. 2 and the system 400 can be part of the same system. In some examples, the system 200 and the system 400 are separate systems. In some examples, the components of the system 200 can run on a user device, and the components of the system 400 can run on a remote server or other computer(s) remote from the user device. The system 400 can communicate with the system 200, e.g., can provide data identifying the skippable segments 422 to the system 200, over a data communication network such as the Internet.

To identify skippable segments 422, the system 400 obtains time ranges 412 for the video. Each time range is a time range within the video that has been designated as a time range that has been skipped by users.

For example, the system 400 can designate the time ranges 412 given user interaction data 402 using a user data processing engine 410. The user interaction data 402 includes data representing user interactions of multiple users with the video over a certain period of time.

As an example, the user interaction data 402 can include data representing time ranges that were skipped. For example, each of the time ranges can include two or more consecutive windows of time for which a measure of skips meets a threshold measure of skips. The measure of skips can be the number of skips relative to the number of views of the video, for example. In some examples, the threshold measure of skips can be the average measure of skips over the windows of time of the video. The user data processing engine 410 can designate time ranges 412 by determining which time ranges within the video were commonly skipped, i.e., skipped in a threshold proportion of views of the video. For example, the user data processing engine 410 can determine a time range is commonly skipped if the measures for a threshold proportion of the windows of the time range indicate that the window was skipped in a threshold proportion of views of the video.

In some examples, the system 400 can generate the user interaction data 402. For example, the system 400 can obtain data indicating the timestamps within the video at which users have provided a user input that was a request to skip a video, and data representing user views. The system 400 can divide the video into windows of time. For example, each window of time can include a predetermined amount of time of the video, such as 1% of the video length. The system 400 can process the data to determine a measure of skips for each window of time of the video.

The system 400 can determine time ranges within the video to include two or more consecutive windows of time for which a measure of skips meets a threshold measure of skips. The measure of skips can be the number of skips relative to the number of views of the video, for example. In some examples, the threshold measure of skips can be the average measure of skips over the windows of time of the video.

As another example, the system 400 can generate the user interaction data 402 using a model such as a machine learning model. The machine learning model can be configured to output data representing time ranges that are likely to be skipped given data representing a video. For example, the machine learning model can have been trained on a training dataset that includes multiple training examples that each include a training input and a target output. Each training input can include data representing a video, and the corresponding target output can include data representing one or more target time ranges. The machine learning model can have been trained to optimize an objective function that measures an error between (i) the predicted output data generated by the machine learning model for a training example and (ii) a target output for the training example.

The system 400 obtains segments 452 within the video. Each segment spans a corresponding segment time range within the video. In some examples, the system 400 can identify the segments given video data 460 for the video using one or more machine learning models 430.

For example, the video data 460 can include the video, or metadata, audio data, image data, and/or text data representing the video. In some examples, the system 400 can derive data representing the video from the video. For example, the system 400 can obtain text data by transcribing audio of the video.

The one or more machine learning models can include a language model neural network 440. The system 400 can provide the transcript of the video as a prompt to language model neural network 440 to obtain an output that identifies portions of text of the transcript as interruptive, not interesting, and/or irrelevant in the context of the transcript. The system 400 can determine the corresponding time range for the identified portions of text by determining the start and end timestamps of the text using the text transcript, for example. The language model neural network 440 is described in more detail below.

In some examples, the one or more machine learning models can include multimodal models such as a visual language model (VLM) neural network or a neural network with a multimodal architecture such as Gemini. For example, the system 400 can provide text data and/or audio data or video data to the VLM neural network to obtain an output that identifies segments as interruptive, not interesting, and/or irrelevant in the context of the video.

In some examples, the one or more machine learning models can include other machine learning models that are configured to generate an output that identifies segments of data representing the video. For example, the one or more machine learning models can have been trained on a training dataset that includes multiple training examples that each include a training input and a target output. Each training input can include data representing a video, and the corresponding target output can include data representing one or more segments. The machine learning model can have been trained to optimize an objective function that measures an error between (i) the predicted output generated by the machine learning model for a training example and (ii) a target output for the training example.

The system 400 can identify the skippable segments using a comparison engine 420. The comparison engine 420 is configured to determine an overlap between each time range of the time ranges 412 and the corresponding segment time range for each segment of the segments 452. The overlap between two time ranges is the amount of time, i.e., the number of timestamps, that is within both time ranges. In some examples, the overlap can be the proportion of the amount of time that is within both time ranges, relative to the amount of time of one of the time ranges. For example, the overlap can be the proportion of the amount of time that is within a time range and a segment time range, relative to the amount of time in the segment time range. The system 400 identifies a segment of the segments 452 as a skippable segment 422 if the overlap between the segment time range and one of the time ranges meets a threshold overlap. The system 400 can output data representing the skippable segments 422 such as the segment time ranges of the skippable segments 422.

For example, the time ranges 412 may include time range A, 3:35-7:02, and time range B, 8:04-9:00. The segment time ranges may include segment time range A, 3:30-7:00. The comparison engine 420 can determine that the overlap between time range A and segment time range A, 3 minutes and 25 seconds (from 3:35-7:00), is about 97.6% of the segment time range A. The threshold overlap can be defined as a percentage, such as 80%, of the segment time range. The system 400 can thus determine that the overlap meets the threshold overlap, and identify segment time range A as a skippable segment.

In some examples, the system 400 can identify the skippable segments using the comparison engine 420 in response to determining that the video of the video data 460 has a threshold age, e.g., using the metadata of the video data 460, or the user interaction data 402 includes a threshold number of user interactions, or both.

In some examples, the system 400 may filter the skippable segments 422 based on length of the skippable segments 422. For example, the system 400 may identify a segment of the segments 452 as a skippable segment 422 if the overlap between the segment time range and one of the time ranges meets a threshold overlap, and if the segment spans a longer portion of the video than a minimum threshold time, and if the segment spans a shorter portion of the video than a maximum threshold time.

The language model neural network 440 can have any appropriate neural network architecture that allows the model to map an input sequence of text tokens from a vocabulary to an output sequence of text tokens from the vocabulary.

For example, the language model neural network 440 can have a long short-term memory (LSTM)-based architecture. For example, the language model neural network 440 can have a Universal Language Model (ULM)-based architecture.

As another example, the neural network 440 can have an encoder-decoder Transformer-based architecture.

As another example, the neural network 440 can have a decoder-only Transformer-based architecture, where the input sequence is provided as a “prompt” to the neural network 440.

In general a Transformer-based architecture can be one which is characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used.

In particular, the neural network 440 can be an auto-regressive neural network that auto-regressively generates the output sequence of text tokens by generating each particular text token in the output sequence conditioned on a current input sequence that includes (i) the input sequence followed by (ii) any text tokens that precede the particular text token in the output sequence.

More specifically, to generate a particular text token, the neural network 440 can process the current input sequence to generate a score distribution, e.g., a probability distribution, that assigns a respective score, e.g., a respective probability, to each token in the vocabulary of text tokens. The neural network 440 can then select, as the particular text token, a text token from the vocabulary using the score distribution. For example, the neural network 440 can greedily select the highest-scoring token or can sample, e.g., using top-k sampling, nucleus sampling or another sampling technique, a token from the distribution.

As a particular example, the neural network 440 can be an auto-regressive Transformer-based neural network that includes a plurality of layers that each apply a self-attention operation. The neural network 110 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J.W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

The tokens in the vocabulary can be any appropriate text tokens, e.g., words, word pieces, punctuation marks, characters, bytes, and so on that represent elements of text in one or more natural languages and, optionally, numbers and other text symbols that are found in a corpus of text. For example, the system 400 can tokenize a given sequence of words by applying a tokenizer, e.g., the SentencePiece tokenizer (Kudo et al., arXiv:1808.06226) or another tokenizer, to divide the sequence into tokens from the vocabulary.

Additionally, or alternatively, the vocabulary of tokens can include tokens that can represent data other than text, such as images, videos, or audio. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

Prior to using the neural network 440 to generate outputs, the neural network 440 is pre-trained e.g., by a training system of the system 100 or by one or more other systems.

In particular, the training system pre-trains the neural network 440 on a language modeling task, e.g., a task that requires predicting, given a current sequence of text tokens, the next token that follows the current sequence in the training data. Equivalently, the language modeling task can require, for each given unlabeled text sequence in a training data set, predicting a text sequence that followed the given unlabeled text sequence in a corresponding document. As a particular example, the language model neural network 440 can be pre-trained on a maximum-likelihood objective on a large dataset of text, e.g., text that is publicly available from the Internet or another text corpus.

In some implementations, the training system further trains, e.g., fine-tunes, the neural network 440 to identify interruptive segments from the text transcript. For example, the neural network 440 can be further trained on training data that includes, for multiple videos, the text transcript for each video and the portions of text that correspond to time ranges that were commonly skipped for the video. For example, the training system can determine the time ranges using the user data processing engine 410 as described above. The training system can determine the portions of text that correspond to the time ranges by identifying text from the text transcript within the time ranges. In some examples, the training data can include, for multiple videos, the text transcript for each video and the portions of text that correspond to skippable segments for the video.

FIG. 5 is a flow diagram of an example process 500 for identifying skippable segments within a video. The process 500 can be performed by any appropriate system, e.g., the system 400 described above with reference to FIG. 4.

The system obtains data identifying one or more segments within a video (step 510). Each of the one or more segments spans a corresponding segment time range within the video. The one or more segments can include content that is interruptive, not interesting, not important, and/or not relevant, for example. In some implementations, the system can identify the one or more segments within the video.

For example, as described with reference to FIG. 4, the system can process a prompt that includes at least the text transcript for the video using a language model neural network to generate an output identifying one or more portions of text of the text transcript. The system can include instructions in the prompt to identify portions of text that are interruptive. The instructions can include a definition of interruptive portions, such as portions that are an introduction, not interesting, not important, and/or not relevant in the context of the text transcript, for example. Each of the identified portions of the output corresponds to a segment within the video. The system can thus identify one or more segments within the video from the portions of text of the output.

In some examples, the system can include different instructions in the prompt depending on the video. For example, metadata for the video may include tags that indicate features of the video. For example, if the metadata indicates that the video includes a promotion, the system can include instructions in the prompt to identify portions of the text that are related to a promotion.

In some examples, the system can include data representing one or more skippable segments for one or more different videos in the prompt. In some examples, the system can include a definition of an interruptive portion as similar to a skippable segment of the one or more different videos.

In some examples, the system can include data representing one or more time ranges that were commonly skipped for one or more different videos in the prompt. In some examples, the system can include a definition of an interruptive portion as similar to a commonly skipped time range of the one or more different videos.

For example, the system can identify one or more videos that are similar, e.g., in text content, visual content, or metadata, to the video. The system can obtain skippable segment data, data representing commonly skipped time ranges, or both, for the one or more identified videos. As a particular example, the system can process a prompt that includes (i) at least the transcript corresponding to each skippable segment for the one or more identified videos, (ii) the text transcript for the video, and (iii) an instruction to identify one or more similar portions of text in the text transcript to the transcript corresponding to each skippable segment using the language model neural network to generate an output identifying one or more portions of text of the text transcript. As another example, the system can process a prompt that includes (i) at least the transcript corresponding to each commonly skipped time range for the one or more identified videos, (ii) the text transcript for the video, and (iii) an instruction to identify one or more similar portions of text in the text transcript to the transcript corresponding to each commonly skipped time range using the language model neural network to generate an output identifying one or more portions of text of the text transcript.

The system can also obtain a segment start timestamp and a segment end timestamp for each of the one or more segments within the video based on the portion of text corresponding to each segment. For example, if the text transcript includes timestamp information, the system can determine the start and end timestamps of the portion of text in the text transcript.

The system obtains one or more time ranges within the video (step 520). Each time range has been designated as a time range within the video that has been skipped by users. For example, each designated time range can have been skipped by users for a threshold proportion of views of the video.

In some implementations, the system can determine the one or more time ranges. For example, as described with reference to FIG. 4, the system can process user interaction data to determine time ranges that have been skipped by users for a threshold proportion of views of the video.

The system performs steps 530-550 for each of the one or more segments, and for each of the one or more time ranges.

The system determines a respective overlap of the time range with the corresponding segment time range for the segment (step 530). For example, the system can determine the proportion of the corresponding segment time range that overlaps with the time range by determining the amount of time that overlaps between the time range and the corresponding segment time range, divided by the amount of time that the corresponding segment time range covers.

The system determines whether the respective overlap meets a threshold overlap (step 540). The threshold overlap can be a predetermined value, such as 80% of the corresponding segment time range. The system can determine that the respective overlap meets the threshold overlap if the respective overlap is greater than or equal to the threshold overlap.

If the system determines that the respective overlap does not meet the threshold overlap, the system does not perform step 550.

In response to determining that the respective overlap meets the threshold overlap, the system identifies the segment as a skippable segment within the video (step 550). The system thus determines skippable segments for the video based on user interactions and content.

The system can output data representing each of the identified skippable segments. For example, the system can output data representing the corresponding segment time range for each of the identified skippable segments. In some examples, the system can maintain the data representing each of the identified skippable segments as skippable segments data 212 described above with reference to FIG. 2.

In some implementations, for each of the identified skippable segments, the system identifies a timestamp associated with the identified skippable segment as a skip location. For example, the system can identify a timestamp that is a threshold amount of time, such as two seconds, before the segment end timestamp, as the skip location. The system can output data representing the skip location.

In some implementations, for each of the identified skippable segments, the system maintains data representing a measure of confidence for the identified skippable segment. As an example, the system can determine the measure of confidence for the identified skippable segment based on the proportion of views of the video for which the identified skippable segment was skipped.

In some implementations, the system determines that the video has a threshold number of user interactions prior to step 510 or step 520. The system will thus not identify skippable segments for videos that do not have a sufficient amount of user interactions, saving computing resources and ensuring that skippable segments are representative of many user preferences. For example, the system can obtain a number of views for the video and a number of skips for the video. The system can determine that the video has a threshold number of user interactions only when the number of views meets a threshold number of views and the number of skips meets a threshold number of skips. In some examples, in response to determining that the video has a threshold number of user interactions, the system can perform steps 510-550. In some examples, in response to determining that the video has a threshold number of user interactions, the system can perform step 520-550.

In some implementations, the system determines that the video has a threshold age (e.g., the elapsed amount of time that the video has been available for viewing by users) prior to step 510 or step 520. The system will thus not identify skippable segments for videos that do not have a sufficient age that are unlikely to have a number of user interactions that is representative of user preferences. The system can save computing resources and ensure that skippable segments are representative of many user preferences. For example, the system can obtain an age for the video, e.g., using metadata for the video. The system can determine that the video has a threshold age only when the age is greater than or equal to the threshold age, e.g., two days. In some examples, in response to determining that the video has a threshold age, the system can perform steps 510-550. In some examples, in response to determining that the video has a threshold age, the system can perform step 520-550.

In some implementations, the system further performs the process 300 described with reference to FIG. 3 for the video. For example, the system can receive, during playback of the video on a display of a device of a user, a user input at a first timestamp of the video. In response to receiving the user input at the first timestamp, the system can determine whether the first timestamp is associated with any of the skippable segments identified in step 550. The system can further identify a skip location for the video and skip playback of the video as described above with reference to FIG. 3.

In some implementations, the system performs the process 500 multiple times for the same video to identify updated skippable segments that take into account new or more recent user interactions. For example, the system can perform the process 500 at regular intervals of time. As a particular example, the system can perform step 520 to obtain updated time ranges based on user interaction data for the video that includes previous user interactions, e.g., for the period of time used to identify the time ranges during the previous iteration of the step 520, and any additional user interactions after the period of time. The system can proceed to perform steps 530-550 for the updated time ranges to identify the updated skippable segments.

In some implementations, the system obtains one or more time ranges within the video based on the one or more segments. For example, the system can determine each time range as the segment time range of one of the one or more segments. The system can perform the process 500 multiple times to identify updated skippable segments. For example, in response to determining that the video has a threshold age, a threshold number of user interactions, or both, the system can perform step 520 to obtain time ranges based on the user interactions. The system can proceed to perform steps 530-550 for the updated time ranges to identify the updated skippable segments.

In some implementations, the system can provide the data representing the identified skippable segments for use by the system or another system. For example, the system can use the data representing the identified skippable segments to exclude the identified skippable segments from a summary of the video.

As an example, the system or another system can generate text descriptions for the video. A search engine can search the text descriptions for multiple videos in response to receiving a query from a user. The text descriptions can include tags that indicate features of the video and/or natural language text that summarizes the content of the video. For example, the system can generate the text descriptions based on the text transcript for the video. The system can use the data representing the identified skippable segments to exclude the identified skippable segments from being represented in the text descriptions. For example, the system can filter text portions corresponding to the identified skippable segments from the text transcript, and then generate the text descriptions based on the filtered text transcript. Excluding the identified skippable segments from the text descriptions results in more focused text descriptions which can lead to more relevant results being presented to the user from the search engine.

In some implementations, the system can identify updated skippable segments that take into account user feedback. For example, the system can identify a potentially skippable segment for a video. The potentially skippable segment can have been identified as a segment using the language model neural network, or as a skippable segment using the process 500. During playback of the video, the system can determine a skip location for the potentially skippable segment.

As an example, the system can receive implicit user feedback. For example, in response to receiving a user input to the user interface element, the system can skip playback to the skip location. If the system receives an input from the user that indicates the user performed a backward seek, the system can determine to shorten the potentially skippable segment, e.g., update the segment end timestamp to an earlier timestamp. If the system receives an input from the user that indicates the user performed a forward seek, the system can determine to lengthen the potentially skippable segment, e.g., update the segment end timestamp to a later timestamp.

As another example, the system can receive explicit user feedback. For example, the system can receive data representing ratings from one or more users that represent a measure of how well the start timestamp and end timestamp of the potentially skippable segment align with their perception of where the segment should start and end. The system can update the potentially skippable segment to be closer to the users' preferences.

In some examples, the system can use reinforcement learning from human feedback (RLHF) to further train the one or more machine learning models based on feedback from one or more users. For example, the feedback from the user can identify that the skip location is too late, e.g., the user performed a backward seek, or that the skip location is too early, e.g., the user performed a forward week. As another example, the feedback can identify a rating from one more users. The system can further train the language model neural network to identify portions of text of the transcript as interruptive, not interesting, and/or irrelevant in the context of the transcript based on feedback from the one or more users.

In some examples, the system can identify one or more initial segments for the video using skippable segment data, data representing one or more commonly skipped time ranges, or both, for one or more different videos. For example, the system can identify one or more videos that are similar, e.g., in text content, visual content, or metadata, to the video. The system can obtain skippable segment data, data representing one or more commonly skipped time ranges, or both, for the one or more identified videos. As a particular example, the system can identify the one or more segments for the video by processing (i) the transcript corresponding to cach skippable segment for the one or more identified videos, (ii) the text transcript for the video, and (iii) an instruction to identify one or more similar portions of text in the text transcript to the transcript corresponding to each skippable segment using a language model neural network to generate an output identifying the initial segments. As another example, the system can process (i) the transcript corresponding to each commonly skipped time range for the one or more identified videos, (ii) the text transcript for the video, and (iii) an instruction to identify one or more similar portions of text in the text transcript to the transcript corresponding to each commonly skipped time range using a language model neural network to generate an output identifying the initial segments.

The system can identify one or more skippable segments for the video using the initial segments. The system can obtain feedback from the user for the video. The system can further train the language model neural network using the feedback from the user.

In some examples, the system can update the potentially skippable segment for a video, i.e., update the segment start and segment end timestamps for the potentially skippable segment, based on feedback from the user for the video. For example, the system can use the further trained language model neural network to obtain updated segments within the video. The system can identify updated skippable segments for the video using the updated segments.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving, during playback of a video on a display of a device of a user, a user input at a first timestamp of the video;
in response to receiving the user input at the first timestamp of the video, determining whether the first timestamp is associated with a skippable segment within the video; and
in response to determining that the first timestamp is associated with a skippable segment within the video, identifying a second timestamp associated with the skippable segment of the video as a skip location.

2. The method of claim 1, further comprising:
providing, for presentation on the device, a user interface element controllable by the user to skip playback of the video to the skip location; and
in response to receiving an input to the user interface element, skipping playback of the video to the skip location by causing the video to be played from the second timestamp.

3. The method of claim 1, further comprising:
skipping playback of the video to the skip location by causing the video to be played from the second timestamp.

4. The method of claim 1, further comprising:
providing, for presentation on the device, an indicator for the skip location.

5. The method of claim 1, wherein the user input is a request to skip a portion of the video.

6. The method of claim 1, further comprising maintaining data identifying one or more skippable segments within the video, and wherein determining whether the first timestamp is associated with a skippable segment within the video comprises determining whether the first timestamp is part of one of the one or more skippable segments.

7. The method of claim 6, wherein the data identifying one or more skippable segments within the video comprises, for each skippable segment, a respective start timestamp and a respective end timestamp, and wherein determining whether the first timestamp is part of one of the one or more skippable segments further comprises:
for each of the one or more skippable segments, determining whether an amount of time between the first timestamp and the respective end timestamp for the skippable segment meets a threshold amount of time.

8. The method of claim 1, wherein the skippable segment is defined by a start timestamp and an end timestamp, and wherein identifying a second timestamp associated with the skippable segment within the video as a skip location comprises identifying a timestamp that is a threshold amount of time before the end timestamp as the second timestamp.

9. A computer-implemented method comprising:
obtaining data identifying one or more segments within a video, wherein each of the one or more segments spans a corresponding segment time range within the video;
obtaining one or more time ranges within the video, wherein each time range has been designated as a time range within the video that has been skipped by users;
for each of the one or more segments:
for each of the one or more time ranges:
determining a respective overlap of the time range with the corresponding segment time range for the segment;
determining whether the respective overlap meets a threshold overlap; and
in response to determining that the respective overlap meets the threshold overlap, identifying the segment as a skippable segment within the video.

10. The method of claim 9, further comprising determining that the video has a threshold number of user interactions, comprising:
obtaining a number of views for the video and a number of skips for the video; and
determining that the number of views meets a threshold number of views and that the number of skips meets a threshold number of skips.

11. The method of claim 9, further comprising identifying the one or more segments within the video, comprising:
processing a prompt comprising at least a text transcript for the video using a language model neural network to generate an output identifying one or more portions of text of the text transcript, each corresponding to a segment within the video; and
identifying one or more segments within the video from the portions of text.

12. The method of claim 11, wherein identifying the one or more segments within the video further comprises:
obtaining a segment start timestamp and a segment end timestamp for each of the one or more segments within the video based on the portion of text corresponding to each segment.

13. The method of claim 9, wherein each designated time range has been skipped in a threshold proportion of views of the video.

14. The method of claim 9, further comprising:
for each of the identified skippable segments within the video, identifying a respective second timestamp associated with the identified skippable segment as a respective skip location.

15. The method of claim 9, further comprising:
receiving, during playback of the video on a display of a device of a user, a user input at a first timestamp of the video;
in response to receiving the user input at the first timestamp of the video, determining whether the first timestamp is associated with a skippable segment of the identified skippable segments within the video; and
in response to determining that the first timestamp is associated with a skippable segment of the identified skippable segments within the video, identifying a second timestamp associated with the skippable segment within the video as a skip location.

16. The method of claim 15, further comprising:
providing, for presentation on the device, a user interface element controllable by the user to skip playback of the video to the skip location; and
in response to receiving an input to the user interface element, skipping playback of the video to the skip location by causing the video to be played from the second timestamp.

17. The method of claim 15, further comprising:
skipping playback of the video to the skip location by causing the video to be played from the second timestamp.

18. The method of claim 15, further comprising:
providing, for presentation on the device, an indicator for the skip location.

19. A system comprising one or more computers and one or more storage devices storing instructions that when executed by the one or more computers cause the one or more computers to perform operations comprising:
receiving, during playback of a video on a display of a device of a user, a user input at a first timestamp of the video;
in response to receiving the user input at the first timestamp of the video, determining whether the first timestamp is associated with a skippable segment within the video; and
in response to determining that the first timestamp is associated with a skippable segment within the video, identifying a second timestamp associated with the skippable segment of the video as a skip location.

20. The system of claim 19, wherein the operations further comprise:
providing, for presentation on the device, a user interface element controllable by the user to skip playback of the video to the skip location; and
in response to receiving an input to the user interface element, skipping playback of the video to the skip location by causing the video to be played from the second timestamp.
